(19) United States
(12) Patent Application Publication
(10) Pub. No.: US 2018/0204252 A1
(43) Pub. Date: Jul. 19, 2018

(54) SYSTEM AND METHOD FOR REPRESENTING THE COSTS OF COMMUTING JOURNEYS

(71) Applicant: Conduent Business Services, LLC, Dallas, TX (US)

(72) Inventors: Cécile Boulard, Grenoble (FR); Frédéric Roulland, Le Versoud (FR); Stefania Castellani, Meylan (FR); Leonid Antsfeld, St. Ismier (FR); Vassilissa Lehoux, Grenoble (FR)

(73) Assignee: Conduent Business Services, LLC, Dallas, TX (US)

(21) Appl. No.: 15/410,021

(22) Filed: Jan. 19, 2017

(51) Int. Cl. G06Q 30/02; G06Q 30/06

(52) U.S. Cl. CPC G06Q 30/0283; G06Q 10/025; G06Q 30/0629; G06Q 30/0206

(57) ABSTRACT

A computer-implemented system and method generate a representation of travel costs for an individual traveler. The method includes computing a fixed community cost component attributable to each traveler in a community, per time period, computing a fixed individual cost component for the individual traveler, per time period, and for each of a set of time periods, computing a variable individual cost component for the individual traveler. For each of the time periods in the set of time periods, the fixed community cost, fixed individual cost, and variable individual cost components are aggregated into an aggregated cost. A representation is generated for displaying the aggregated costs for the set of time periods to the individual traveler, in which the three cost components are identified.

### BACKGROUND

This application relates to providing information to travelers and finds particular application in a system and method for visualizing economic and environmental costs of different modes of transport for journeys taken or for planning of new journeys.

Mobility is beneficial to the economic and daily activities of people. At the same time, mobility, and in particular commuting, within a urban area incurs costs for society, since it is largely based on single-occupancy vehicle usage and uses resources that involve significant, direct or indirect environmental costs for citizens. Travelers often have alternative transportation modes available to them (car, bus, train, bicycle, walking, etc.) which have different environmental impacts. In order to encourage travelers to make behavioral changes towards more sustainable transportation choices, it would be beneficial for travelers to have a good understanding of the costs and benefits associated with each transportation choice. This would help them to make informed decisions on the transportation modes to be used.

Information on the environmental impact of modes of transport is often expressed in terms of carbon emissions. A wide variety of trip planning and navigation tools, information systems, carbon footprint calculators, and the like are available that can provide travelers with suggestions for possible itineraries for planning a trip, which may provide them with information on the trip characteristics, costs, and so forth. A ranking mechanism may be used that is based on metrics that capture the trips' duration, financial cost, comfort, environmental impact, or the like. One example of such a tool is a Cost of Commute Calculator (see, Stewart-Wilson, et al., at movingforward.discoursemedia.org, 2015). This interactive tool aims to capture the full cost and benefit of driving, taking the bus, cycling and walking, in the Metro Vancouver area. Infrastructure costs, such as building roads and bridges, and the costs of operating public transport, emissions, climate change, accidents, congestion and noise pollution, are considered. This provides the traveler with a global view of the costs of different transportation options, from the individual and the societal points of view.

However, when presented with information on environmental costs, e.g., in terms of the estimated mass of carbon dioxide produced, travelers may have difficulty in interpreting the information (see, e.g., Brazil, et al., “Testing Individuals' Ability to Compare Emissions from Public Transport and Driving Trips,” J. Public Transportation, Vol. 17, No. 2, 2014, hereinafter, “Brazil 2014”; Waygood, et al., “Does “500 g of CO₂ for a five mile trip” mean anything? Towards more effective presentation of CO₂ information,” Proc. Transportation Research Board, 90th Annual Meeting, pp. 23-27, 2011, hereinafter, “Waygood 2011”; Betz, et al., “Know Thyself: Monitoring and Reflecting Energy Consumption,” CHI 2010, 2010, hereinafter, “Betz 2014”). The same applies to other kinds of parameters, such as financial costs of the mobility for individuals.

In addition, these metrics often fail to capture the actual cost of mobility activities of individuals, for example of the different options for a trip, and to support a fair and realistic comparison among the options. In part, this may be due to the complexity of modeling and computing cost estimations for trips which comprehend some variable costs associated to the incremental use of a resource and some structural fixed cost associated to the availability of the resource.

A system and a method are provided which represent these costs to travelers in a more meaningful way.

### INCORPORATION BY REFERENCE

The following references, the disclosures of which are incorporated by reference in their entireties, are mentioned:

U.S. Ser. No. 14/737,964, filed Jun. 12, 2015, entitled LEARNING MOBILITY USER CHOICE AND DEMAND MODELS FROM PUBLIC TRANSPORT FARE COLLECTION DATA, by Ulloa Paredes, et al.; U.S. Ser. No. 14/831,326, filed Aug. 20, 2015, entitled SYSTEM AND METHOD FOR MULTI-FACTORED-BASED RANKING OF TRIPS, by Céret, et al.; U.S. Ser. No. 14/837,070, filed Aug. 27, 2015, entitled METHOD AND SYSTEM FOR SCHEDULING VEHICLES ALONG ROUTES IN A TRANSPORTATION SYSTEM, by Mukherjee, et al.; U.S. application Ser. No. 14/963,543, filed Dec. 9, 2015, entitled A SYSTEM AND METHOD FOR GENERATING AVAILABLE RIDE-SHARE PATHS IN A TRANSPORTATION NETWORK, by Ulloa Paredes, et al.; U.S. Ser. No. 15/097,578, filed Apr. 13, 2016, entitled SYSTEM AND METHOD FOR PROMOTING SUSTAINABLE COMMUTING BEHAVIOR, by Castellani, et al.; U.S. Pub. No. 20120033250, published Feb. 9, 2012, entitled VIRTUAL PRINTING CURRENCY FOR PROMOTING ENVIRONMENTAL BEHAVIOR OF DEVICE USERS, by Grasso, et al.; U.S. Pub. No. 20130317742, published Nov. 28, 2013, entitled SYSTEM AND METHOD FOR ESTIMATING ORIGINS AND DESTINATIONS FROM IDENTIFIED END-POINT TIME-LOCATION STAMPS, by Ulloa Paredes, et al.; U.S. Pub. No. 20140180651, published Jun. 26, 2014, entitled USER PROFILING FOR ESTIMATING PRINTING PERFORMANCE, by Lysak, et al.; U.S. Pub. No. 20150199633, published Jul. 16, 2015, entitled ADAPTIVE PLANNING OF PUBLIC TRANSPORTATION, by Convertino, et al.; U.S. Pub. No. 20150317568, published Nov. 5, 2015, entitled SYSTEM AND METHOD FOR FLEXIBLE CARPOOLING IN A WORK CONTEXT, by Grasso, et al. U.S. Pub. No. 20160033283, published Feb. 4, 2016, entitled EFFICIENT ROUTE PLANNING IN PUBLIC TRANSPORTATION NETWORKS, by Ulloa Paredes; U.S. Pat. No. 5,021,953, issued Jun. 4, 1991, entitled TRIP PLANNER OPTIMIZING TRAVEL ITINERARY SELECTION CONFORMING TO INDIVIDUALIZED TRAVEL POLICIES, by Webber, et al.; U.S. Pat. No. 6,622,084, issued Sep. 16, 2003, entitled TRAVEL ROUTE PLANNER SYSTEM AND METHOD, by Cardno, et al.; U.S. Pat. No. 6,961,756, issued Nov. 1, 2005, entitled INNOVATION MANAGEMENT NETWORK, by Dilsaver, et al.; U.S. Pat. No. 7,925,540, issued Apr. 12, 2011, entitled METHOD AND SYSTEM FOR AN AUTOMATED TRIP PLANNER, by Orttung et al.; U.S. Pat. No. 8,280,769, issued Oct. 2, 2012, entitled METHOD AND APPARATUS FOR ADMINISTERING A REWARD PROGRAM, by Walker, at al.; U.S. Pat. No. 8,494,771, issued Jul. 23, 2013, entitled JOURNEY PLANNING IN PUBLIC TRANSPORTATION NETWORKS, by Delling, et al.; U.S. Pat. No. 8,503,016 entitled SYSTEM AND METHOD FOR PROVIDING ENVIRONMENTAL FEEDBACK TO USERS OF SHARED PRINTERS, by Grasso, et al.; U.S. Pat. No. 8,583,363, issued Nov. 12, 2013, entitled DETERMINING ALTERNATIVE ROUTES, by Abraham, et al.; U.S. Pat. No. 8,712,676, issued Apr. 29, 2014, entitled METHOD FOR COMPUTING AN ENERGY EFFICIENT ROUTE, by Hiestermann, et al.; U.S. Pat. No. 8,725,612, issued May 13, 2014, entitled PERSONALIZED REAL-TIME LOCATION-BASED TRAVEL MANAGEMENT, by Mundinger, et al.; and U.S. Pat. No. 8,738,286, issued May 27, 2014, entitled TRANSIT ROUTING SYSTEM FOR PUBLIC TRANSPORTATION TRIP PLANNING, by Bast, et al.

### BRIEF DESCRIPTION

In accordance with one aspect of the exemplary embodiment, a method for representing travel costs for an individual traveler includes computing a fixed community cost component attributable to each traveler in a community, per time period, computing a fixed individual cost component for the individual traveler, per time period, and for each of a set of time periods, computing a variable individual cost component for the individual traveler. For each of the time periods in the set of time periods, the fixed community cost, fixed individual cost, and variable individual cost components are aggregated into an aggregated cost. A representation is generated for displaying the aggregated costs for the set of time periods to the individual traveler.

At least one of the computing the fixed community cost, computing the fixed individual cost, computing the variable individual cost, aggregating the fixed community cost, fixed individual cost, and variable individual cost, and generating a representation may be performed with a processor.

In accordance with another aspect of the exemplary embodiment, a system includes a data acquisition component which acquires community data and user data. A travel cost metric computation component computes a fixed community cost component attributable to each traveler in a community, per time period, based on the community data, a fixed individual cost component for the individual traveler, per time period, based at least in part on the user data, and for each of a set of time periods, a variable individual cost component for the individual traveler, based at least in part on the user data. For each of the time periods in the set of time periods, the travel cost metric computation component aggregates the fixed community cost, fixed individual cost, and variable individual cost components. A representation generator generates a representation for displaying the aggregated costs for the set of time periods to the individual traveler. A processor implements the data acquisition component, travel cost metric computation component, and representation generator.

In accordance with another aspect of the exemplary embodiment, a trip-planning method includes computing a fixed community cost component attributable to each traveler in a community, per time period and computing a fixed individual cost component for an individual traveler, per time period. A query is received for a trip from the traveler. A variable individual cost component is computed for the individual traveler for each of a set of proposed trips. The fixed community cost, fixed individual cost, and variable individual cost components are aggregated for each of the proposed trips. The proposed trips are ranked, based on the aggregated cost for each. A representation is generated for displaying at least some of the ranked proposed trips. The representation includes at least one of a representation of the variable cost and a representation of the aggregated cost for each displayed proposed trip.

At least one of the computing the fixed community cost, computing the fixed individual cost, computing the variable individual cost, aggregating the fixed community cost, fixed individual cost, and variable individual cost, ranking, and generating a representation may be performed with a processor.

### BRIEF DESCRIPTION OF THE DRAWINGS

FIG. 1 is a functional block diagram of a system for computing and visualizing costs of journeys in accordance with one aspect of the exemplary embodiment;

FIG. 2 is a flowchart illustrating a method for computing and visualizing costs of journeys in accordance with another aspect of the exemplary embodiment;

FIG. 3, which is split, for ease of illustration only, into FIGS. 3A and 3B, illustrates an example of a graphical representation of a history of commuting over a month showing the economic and environmental costs;

FIG. 4 illustrates a commuting diary in accordance with another aspect of the exemplary embodiment;

FIG. 5, which is split, for ease of illustration only, into FIGS. 5A and 5B, illustrates an example of a graphical representation of a history of commuting over a month showing the fixed economic and environmental costs;

FIGS. 6-8 illustrate simulations of economic commuting costs for three different passengers; and

FIG. 9-11 illustrate simulations of environmental commuting costs for the three different passengers.

### DETAILED DESCRIPTION

A system and method are provided for generating a graphical representation of the financial and environmental costs for passenger trips made by an individual traveler over a period of time in a community, such as transportation region or an urban area. The graphical representation may be displayed to the traveler and may assist the traveler in future trip planning.

The exemplary system and method described herein provide for computing the estimated total costs (monetary and/or environmental) of trips for a given time period, such as a day. The total costs are based on a decomposition of the total cost into 3 additive components: fixed community cost (FCC), fixed individual cost (FIC), and variable individual cost (VIC). FCC can be estimated as the public spending on public transportation sponsorship or infrastructure per capita per year. FIC can be computed from surveys or user-provided information. VIC is estimated depending on the transport mode, provided that personal travel information is available. The system presents this three-part cost to a user, and allows for comparing among alternative transport modes or to other travelers' costs.

The exemplary system and method have several advantages over existing approaches. The graphical representation provided by the system/method represents the data of a specific user, taking into account his or her own context. It represents the data to the users in an efficient way, allowing the user to consider the change availabilities. Through a representation of fixed and variable costs, the graphical representation makes it possible for the user to understand more fully what the costs are for each cost category, and how it would be possible to change it. Additionally, the data representation differentiates and considers several costs, including the financial costs (money) and the environmental costs (e.g., in terms of the quantity of CO₂ emitted). Further, the data calculation supports a clearer understanding of what the quantities mean.

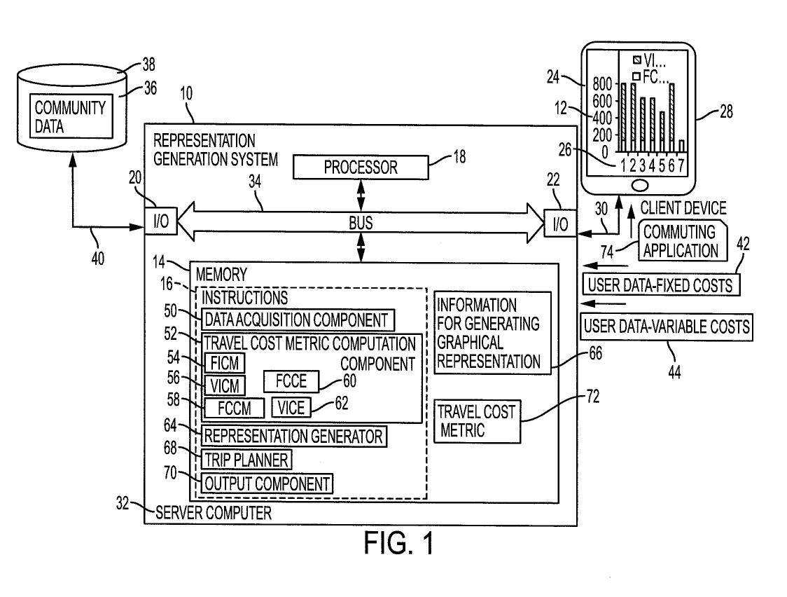

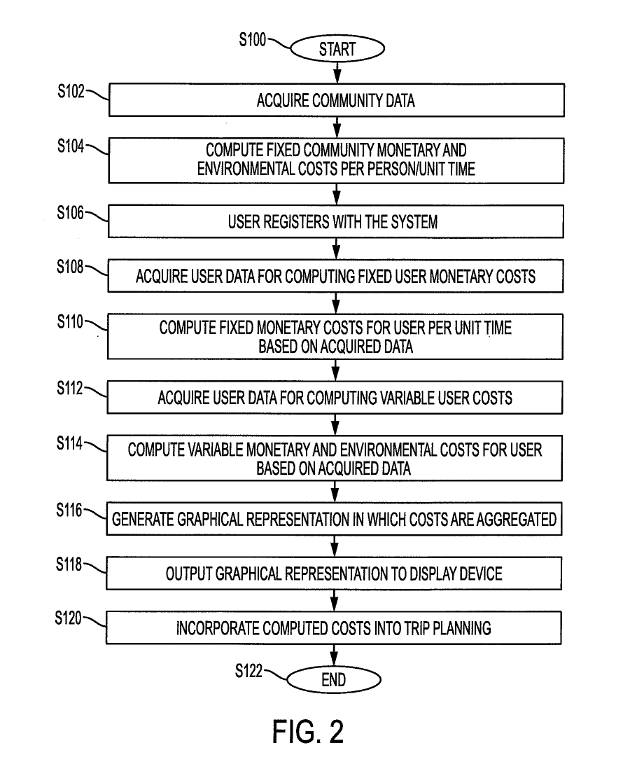

With reference to FIG. 1, a functional block diagram of a computer-implemented system 10 for generating a graphical representation 12 of the costs for passenger trips is shown. The illustrated computer system 10 includes memory 14 which stores software instructions 16 for performing the method illustrated in FIG. 2 and a processor 18 in communication with the memory for executing the instructions. The system 10 also includes one or more input/output (I/O) devices, such as a network interface 20 and/or a user input output interface 22. The I/O interface 22 may communicate with one or more of a display device 24, for displaying information to users, speakers, and a user input device 26, such as a keyboard or touch or writable screen, and/or a cursor control device, such as mouse, trackball, or the like, for inputting text and for communicating user input information and command selections to the processor device 18. The display device 24 and user input device 26 may form a part of a client device 28 operated by an individual traveler, and having memory and a processor analogous to memory 14 and processor 18. The client device 28 may be communicatively connected with the I/O interface 22 via a wired or wireless link 30, such as a local or wide area network, such as the Internet, or a phone link. In other embodiments, the display device 24 and user input device 26 may form a part of the same computing device 32 as the system. The various hardware components 14, 18, 20, 22 of the system 10 may all be connected by a data/control bus 34.

The system 10 has access to community data 36, which may be made available on a remote memory storage device or devices 38, by one or more transportation providers. The system may access the community data via a wired or wireless link 40, such as a local or wide area network, such as the Internet, or a phone link, to the interface 20 or 22. The system 10 also has access to user data 42, 44 related to fixed and variable transportation costs incurred by the user. The data 42, 44 may be made available to the system from the client device 28, via the link 30, or from another source of user data. As will be appreciated, there may be several client devices communicatively connected with the system 10.

The computer system 10 may include one or more computing devices 32, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 14 may represent any type of non-transitory computer readable medium such as random access memory (RAM), read only memory (ROM), magnetic disk or tape, optical disk, flash memory, or holographic memory. In one embodiment, the memory 14 comprises a combination of random access memory and read only memory. In some embodiments, the processor 18 and memory 14 may be combined in a single chip. Memory 14 stores instructions for performing the exemplary method as well as the processed data.

The exemplary interface 20, 22 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 18 can be variously embodied, such as by a single-core processor, a dual-core processor (or more generally by a multiple-core processor), a digital processor and cooperating math coprocessor, a digital controller, or the like. The digital processor 18, in addition to executing instructions 16 may also control the operation of the computer 32.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or the like, and is also intended to encompass so-called “firmware” that is software stored on a ROM or the like. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The exemplary instructions 16 include a data acquisition component 50 for acquiring community data 38 and user data 42, 44. A travel cost metric computation component 52 includes components 54, 56, 58, 60, 62 for computing a Monetary Fixed Individual Cost (FICM), a Monetary Variable Individual Cost (VICM), an Environmental Fixed Community Cost (FCCE) and an Environmental Variable Individual Cost (VICE), based on the acquired data 36, 42. A representation generator 64 generates the graphical representation 12, or information 66 from which it can be generated on the client device 28. A trip planner 68 optionally generates proposed trips for a user, which take into account the individual and community environmental and monetary costs. An output component 70 outputs the information 66/graphical representation 12 to the display device 24/client device 28.

The travel cost metric computation component 52 employs a travel cost metric 72 that considers three components:

1. Community fixed costs 58, 60, that is, the costs that are associated with the provision of transportation services to the community in a transportation region, which makes use of the already available transport data sources 36;

2. Individual fixed costs 54, that is, the costs for individuals that are associated with their mobility and that are constant; and

3. Individual variable costs 56, 62, that is, the costs for individuals associated with their mobility, which can vary over time.

The representation generator 64 represents the costs of travel (e.g., commuting costs) for a given person computed with the travel cost metric 72. These costs may be represented over time in a representation 12/travel diary for awareness and simulation purposes and/or may be used by the trip planner 68 at the time of a trip planning as part of the generation (ranking) of the results as a relative cost increase of one option with respect to fixed costs.

The system enables a personalized understanding of commuting practices and highlights margins (in the variable costs) to let the user improve on various costs. The system is able to provide the user with an accurate and factual estimation of costs of commuting with different transport modes.

The system may also incorporate a mobile payment system, enabling a user to pay for the selected transportation.

In various embodiments, the user downloads a commuting application 74 onto the client device 28, which enables the user to access the various functionalities of the system, and upload user data 42, 44 to the system, either automatically or manually.

The representation 12 enables commuters to understand the costs of their commuting habits and choices and make more informed decisions on the transportation modes that they could use in the future.

FIG. 2 illustrates a method for generating a representation which can be performed with the system of FIG. 1. The method begins at S100.

At S102, community data 36 for a geographical region is acquired.

At S104, fixed community monetary and environmental costs 58, 60 are computed per person per day (or other fixed time period) based on the acquired community data.

At S106, a user registers with the system.

At S108, user data 42 for computing fixed costs is acquired for the specific user.

At S110, fixed individual monetary costs 54 are computed per person per day (or other fixed time period) based on the acquired fixed cost user data 42.

At S112, user data 44 for variable costs is acquired for the specific user, which may include details of the journeys made over the course of several days and the modes of transport used for these journeys.

At S114, variable individual monetary and environmental costs 56, 62 are computed per person per day (or other fixed time period) based on the acquired user variable cost data 44.

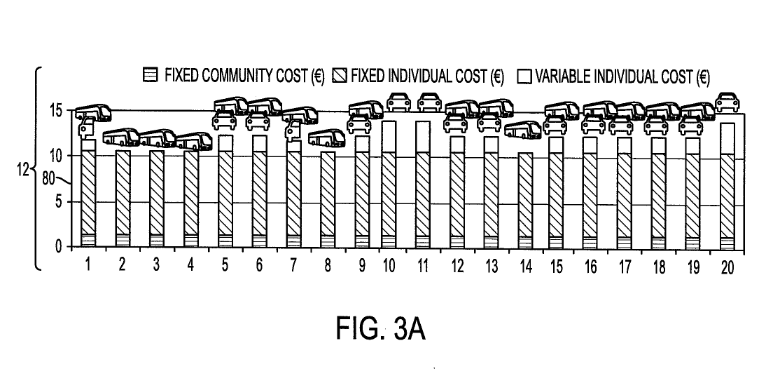

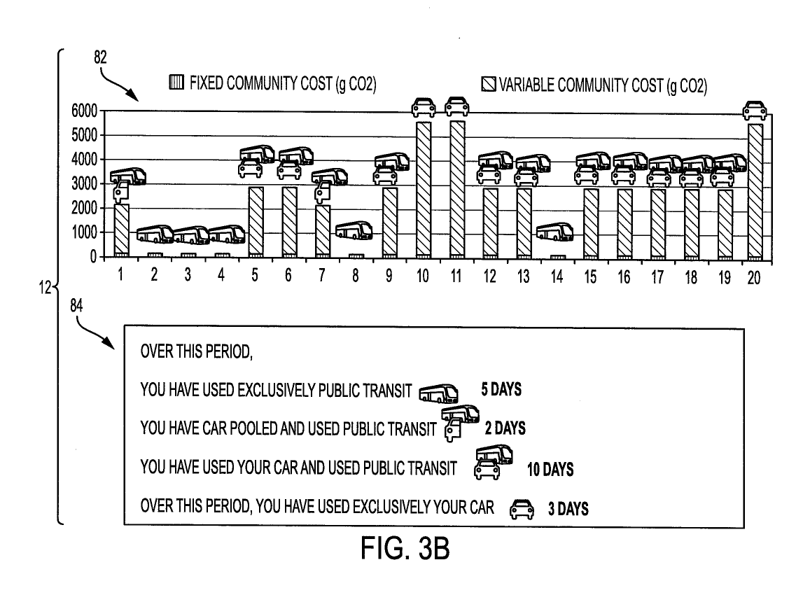

At 116, a graphical representation 12 of the user's total monetary costs and total environmental costs is generated, by the representation generator 64. The representation may illustrate the costs in the form of a bar graph or graphs, as shown in FIGS. 3A and 3B, with the different cost component(s) which make up the total cost being illustrated on the bars of the bar graphs using different shading, colors, patterns, or the like, stacked one on top of the other.

At S118, the graphical representation 12 (or information 66 from which it can be generated) is sent, by the output component 70, to the client device 28/display device 24 where it is displayed to the user.

At S120, the user may employ a trip planning application on the client device 28 to plan a trip. The client device sends the user's criteria for trip selection to the system, where it is processed by the trip planner 68 to propose a set of alternative trips. The variable community and user variable costs associated with each trip are computed and the fixed costs are retrieved. These costs may be aggregated and displayed to a user in a graphical representation, as for the past trips, and/or may be used in ranking the trips

The method ends at S122.

The method illustrated in FIG. 2 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 32, (for example, an internal hard drive of RAM), or may be separate (for example, an external hard drive operatively connected with the computer 32), or may be separate and accessed via a digital data network such as a local area network (LAN) or the Internet (for example, as a redundant array of inexpensive or independent disks (RAID) or other network server storage that is indirectly accessed by the computer 32, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2, can be used to implement the method for representing daily costs of trips. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details of the system and method will now be described.

### User Registration (S106)

At registration time the user downloads the commuting cost application 74 onto his or her computer device 28, such as a smartphone. The user may be prompted to provide information such as annual maintenance and purchase costs of his vehicle, fuel consumption per mile when using his vehicle for commuting, costs of parking and transit passes, whether carpooling is an option (and optionally an identifier of another user of the system with whom the user carpools so that the actual costs can be shared), the commuting distance, the modes of public transit used (e.g., bus, rail, subway, etc.), and so forth. The system can then generate icons or other identifiers for the user to select his or her mode(s) of transport on a given day or can use the provided information to assist the system in inferring the likely mode of transport. If the user chooses not to provide specific information for her vehicle, the system may use publically-available information to infer the costs of ownership, fuel consumption, etc.

### Metrics Computation (S104, S110, S112)

The following three cost components are computed:

### 1. Community Fixed Costs

Community fixed costs 58, 60 can be computed (at S104) using public documents produced by urban area governments and/or other transportation providers. Two types of information may be employed:

1. Information about the population, which can be obtained from census data. The population living in the area is used as a reference. There is no need to distinguish these people according to their activities or their home location; they can be considered equally. The population may be the entire population of the area, or a subset, such as people over a certain age, taxpayers, or the like.

2. Information about transport spending. This may include all public expenditures associated with transportation, such as road/infrastructure building and repair costs and costs associated with the providing of public transit (in excess of revenues received). This information may be made available in a publication of the local government's budget. For the environmental costs 60 (CO₂ emission), only the costs of public transit need be considered. The CO₂ emission figures may be obtained from the transportation authority directly or they may be inferred from the fuel consumption and/or the number of miles traveled by the vehicles in the transportation network serving the transportation region.

The total transportation spending cost is divided by the number of inhabitants and the days in the year to obtain the community fixed costs (per inhabitant, per day) 58, 60.

The fixed community costs are thus attributed to each person equally, irrespective of their transport choice, if any, on a given day.

### 2. Individual Fixed Costs

Individual fixed costs 54 computed at S110 may be associated with two elements: the costs associated with the ownership of vehicle(s) and the costs of monthly or annual public transit and/or parking passes. Vehicle ownership costs may include the cost of vehicle acquisition, maintenance costs, insurance cost, and registration cost. An average figure can be sourced from public survey results available at the national level or at the local level. Alternatively, each individual user of the system may enter his/her own data. The spending on public transit or parking passes may be collected from each user.

Fixed costs can therefore be computed as follows:

$$Fixed community monetary cost ( FCCM ) = \frac{T}{P \times D}$$

$$Fixed community environmental cost ( FCCE ) = \frac{C}{P \times D}$$

$$Fixed individual monetary cost ( FICM ) , for vehicle owners = \frac{O}{V \times D} or \frac{{O}_{I}}{D} ,$$

Where T is the total annual monetary costs incurred by the community associated with providing transport, P is the population, D is the number of days in the year, C is the total annual environmental costs incurred by the community associated with providing transport, such as the annual CO₂ emissions of its vehicles, O is the total annual monetary costs incurred by the users, V is the number of vehicle owners in the area, where the costs are averaged over vehicle users, or where individuals provide their own annual fixed data O₁, this can be used instead.

For the examples used below, all the required information listed for community fixed costs and individual fixed costs was collected from a public document which is produced by each urban area in France that is larger than 100,000 inhabitants. As an example, for one urban area in a given year, the information obtained was as follows:
Number of inhabitants P: 407,000
Community transportation costs T: 208 Million Euros
CO₂ Community costs C: 20,540 tons
Number of cars in the urban area V: 232,000

The fixed community costs 58, 60 are then computed as follows:
Computed Community fixed cost/day 58: 208,000,000/407,000/365=1.4€
Computed Community CO₂ emission in grams/person/day 60: 20,540*10⁶/407,000/365=138 g
Spending on insurance: 101 M€
Spending on maintenance: 260 M€
Spending on acquisition: 365 M€
Individual Fixed cost per day for car ownership: (101+260+365)*10⁶/232000/365=8.56€

As will be appreciated, although these costs are described as “fixed,” it does not mean that they cannot change over time. They are fixed in the sense that they do not change based on the mode of transport that the user selects for a given day. The fixed community and individual costs may be updated periodically (e.g., annually or monthly) and/or when there is a significant change. For example, a user may buy a new car and have higher average car payments and insurance, or may decide to sell his car and rely on public transport. Similarly, a community may change from diesel to electric vehicles, lowering the average daily emissions, or add more transit routes, increasing the fixed community costs.

### 3. Individual Variable Costs

Individual variable costs computed at S114 are those costs which are generated when moving, which are in excess of the individual fixed costs. These may be computed as follows:

A. Financial costs: These include the individual's daily costs that are incurred when using a public transit service (when not using a multi-day (e.g., monthly) pass), a taxi, or a car/bike rental, cost of the fuel consumed when using a private car or rental car, daily parking fees, road tolls, and which vary depending on the mode of transport selected on a given day. The variable financial costs may be shared among the occupants when there is more than one occupant of a vehicle, such as when people carpool to work. For example, when two people share a car, the variable costs are shared equally among them so that each has a lower variable cost than for the single-occupancy case.

For CO₂ costs: The use of a private vehicle (including a taxi) accounts for the whole vehicle CO₂ emissions, if used as a single occupancy, and is divided by the number of occupants otherwise. Usage of public transit services does not account for extra CO₂ emission since those are already included in the community fixed costs.

### Representation (S118)

As illustrated in FIG. 3, the graphical representation 12 may be in the form of temporal graphs 80 (FIG. 3A), 82 (FIG. 3B) for the financial and environmental costs of the user activity over the course, for example of a month or a set number of days, such as at least 10 days, or the last 20 days on which the user chose to log their activity. The representation may be displayed, using one series for each of the metric components:
1. Community fixed costs
2. Individual fixed costs
3. Individual variable costs

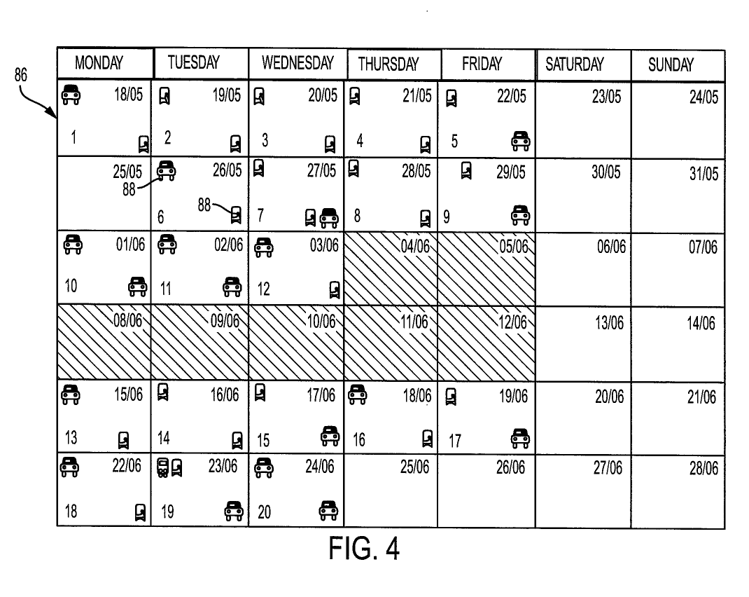

For example, the days are represented as bars with the different components of the total separately identified, for example with different colors or shading for the fixed community costs, individual fixed costs, and individual variable costs. Separating the different elements/types of the global cost allows the system to more clearly and in a more meaningful way show to the individuals the costs that are really generated by their own mobility behaviors and choices. Each day may be associated with an indicator of the mode(s) of transport utilized from a finite set of modes, such as an icon, as shown, a colored circle around the day, or the like. The exemplary modes are public transit, car, and carpooling, although the set may include more or different modes, such as bus, train, subway, taxi, car, carpooling, bicycle, walking, combinations thereof, and so forth. The representation may also include a summary 84 of the number of days each mode of transport (or combination of modes) was used. The information on the modes of transport used may be entered by the user or may be gathered automatically. If automatically, the information may be inferred from one or more of: an accelerometer in the user's device (different modes of transport have different patterns and speeds), geolocation information (which could be associated with public transit routes or car routes), records of the user's travel pass or parking pass being used, and so forth. For example, as shown in FIG. 4, a diary 86 shows the transportation modes used. The user can click on a day and enter the modes of transportation used, which can be represented by icons 88.

As an example, consider the case of a person who owns a car and a monthly public transit pass and who is commuting a 20 km distance from home to work. This person uses a combination of public transit and his car and also sometimes carpools. FIG. 4 shows an example of his travel diary 86 over one month (20 working days) showing the transportation modes used by the commuter. The graphs in FIGS. 3A and 3B show his costs in two cost dimensions, expenses (in Euros) and CO₂ emissions (in grams), calculated using the above metrics. Indicators represent the days where the commuter has car-pooled and used public transit; the days where the commuter has used public transit; the days where the commuter has used his personal car and used public transit; and the days when the commuter has used his personal car only.

From this representation, it can be easily recognized which combination of transport modes was used by the commuter and it can be seen that in both dimensions (financial and pollution) the relative ordering of the costs is logical with the combination of the transportation modes being used, i.e., the less resources are shared, the more expensive is the mobility.

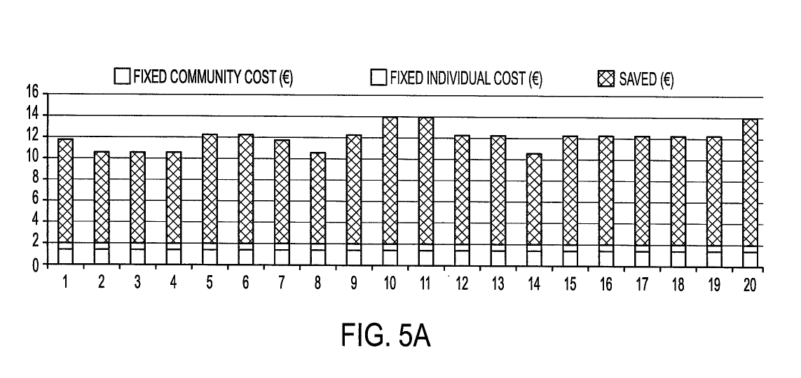

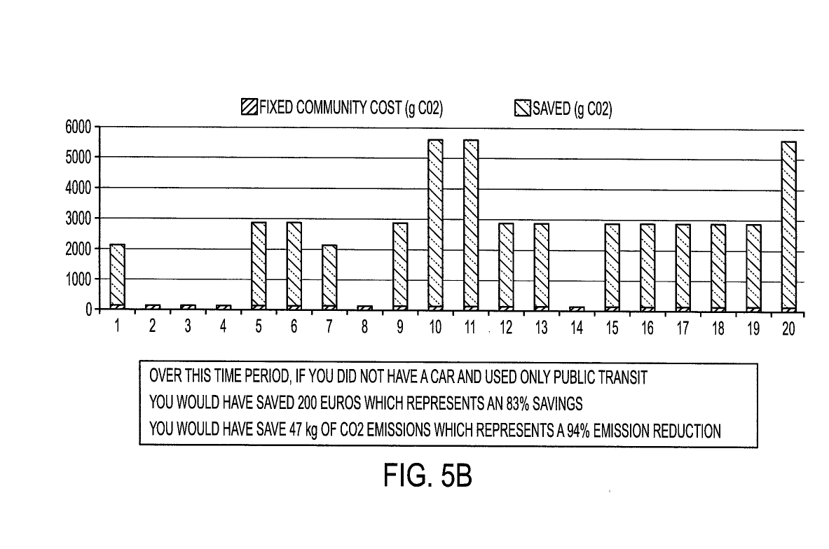

Moreover, these metrics may also help to show to the users a more representative comparison among the costs generated by the different transportation choices that they could make to simulate for example different alternatives. For instance, if the same commuter profile as in the previous example is considered, the commuter can make a simulation of the impact of getting rid of the car and use exclusively public transit. FIGS. 5A and 5B show an example of the simulated scenario.

In an analogous way, a simulation for the future could be generated using records of what has happened in the past in a corresponding period of time of the year.

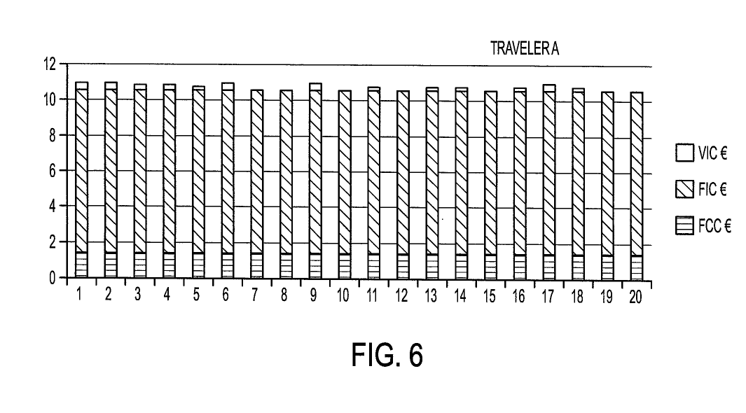

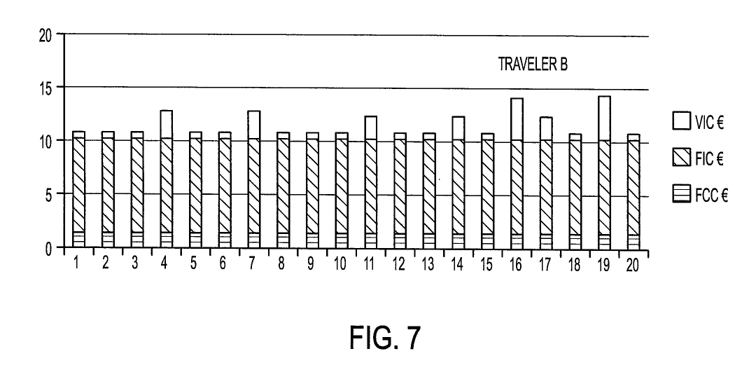

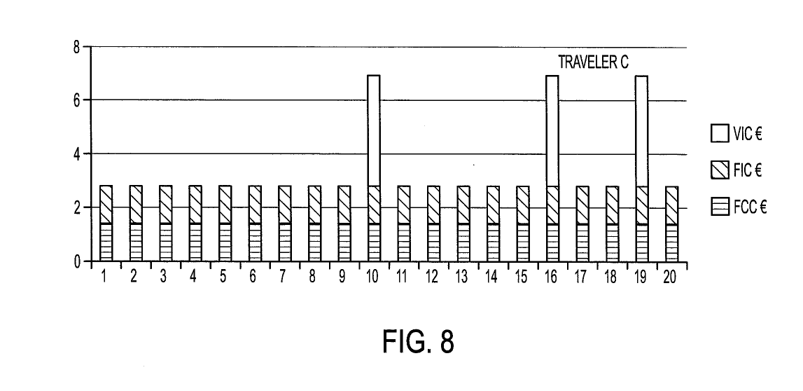

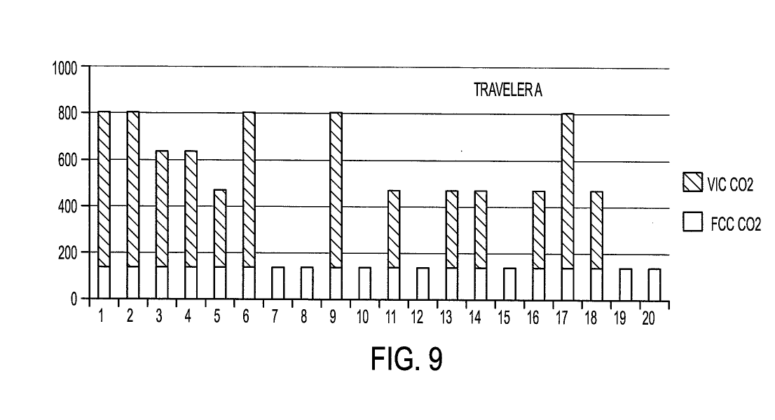

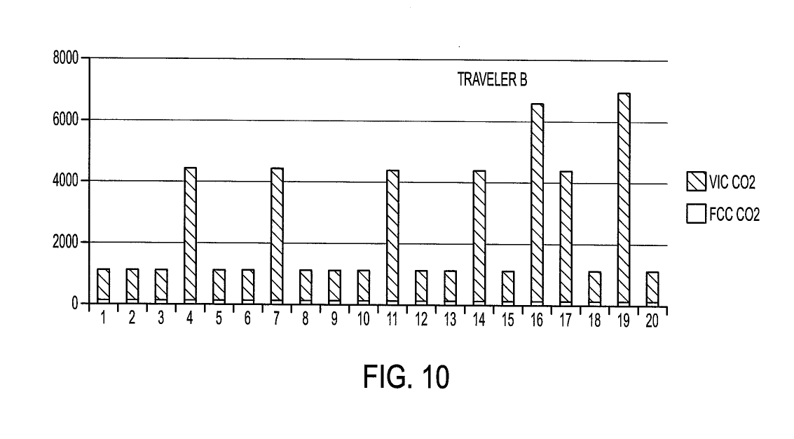

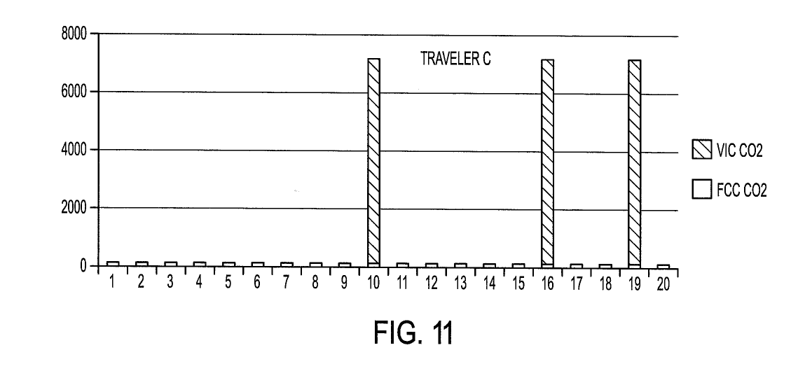

A comparison can also me made with the costs generated by other individuals (family, neighbors, work colleagues, local community, region, country, etc.), as shown in the profiles shown in FIGS. 6-8 (financial) and FIGS. 9-11 (environmental) that represent the costs overtime respectively for:
1. Person A having a short commute (e.g., 3 km), owning a car and a monthly public transit pass;
2. Person B having a long commute (e.g., 30 km), owning a car and a monthly public transit pass;
3. Person C having a long commute (e.g., 40 km), without a car but with a monthly public transit pass, sometimes carpooling.

It can be seen from the respective graphs that the distance has a strong impact on the variable costs. For the travelers B and C, their variable costs (euros and CO₂) vary significantly compared to traveler A.

### Trip Planner Results (S120)

When applied to a trip planner application, the exemplary metrics 72 can be used to produce a new ranking criterion for the proposed itineraries resulting from a user query. As an example, the individual's variable costs divided by the sum of the community and individual fixed costs can be used as one of several factors (or the only factor) in the ranking.

The two tables below show an example of potential ranking results and criteria values for a person who owns a car and a monthly public transit pass and is commuting a 20 km distance from home to work (as described in the previous Example). The fixed costs is used as the baseline (0% additional cost) for computing the additional costs of the options.

TABLE 1

| Itineraries | Additional Cost | Total Cost (Euros) |
|---|---|---|
| Public transit | 0% | 10.56 |
| Public transit + car pooling | 11% | 11.76 |
| Public transit + car | 16% | 12.26 |
| Car only | 32% | 13.96 |

TABLE 2

| | Additional | |
|---|---|---|
| Itineraries | CO₂ Emissions | Total Emissions (g) |
| Public transit | 0x | 138 |
| Public transit + car pooling | 14x | 2138 |
| Public transit + car | 20x | 2874 |
| Car only | 39x | 5610 |

The displayed ranking order may be based the financial cost, the environmental cost, or a combination of both.

As will be appreciated, other dimensions may be used in the ranking, such as trip duration. Additionally, if the user plans more than one trip in a day, the fixed community and individual costs are apportioned among the trips.

The system 10 may be incorporated in or incorporate a trip planning application 68 as described, for example, in above-mentioned U.S. application Ser. No. 14/831,326 and/or U.S. Pub. No. 20160033283.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for representing travel costs for an individual traveler, comprising:
computing a fixed community cost component attributable to each traveler in a community, per time period;
computing a fixed individual cost component for the individual traveler, per time period;
for each of a set of time periods, computing a variable individual cost component for the individual traveler;
for each of the time periods in the set of time periods, aggregating the fixed community cost, fixed individual cost, and variable individual cost components; and
generating a representation for displaying the aggregated costs for the set of time periods to the individual traveler,
wherein at least one of the computing the fixed community cost, computing the fixed individual cost, computing the variable individual cost, aggregating the fixed community cost, fixed individual cost, and variable individual cost, and generating a representation is performed with a processor.

2. The method of claim 1, wherein the generating of the representation for displaying the aggregated costs comprises generating a first representation of aggregated monetary costs for the set of time periods and generating a second representation of aggregated environmental costs for the set of time periods.

3. The method of claim 1, wherein the fixed community cost component is based on community transport infrastructure costs, and community costs of purchase, maintenance, and operation of public transit vehicles.

4. The method of claim 1, wherein the fixed individual cost component is based on at least one of the individual traveler's costs of purchase and maintenance of the individual's vehicle, parking passes, and transit passes.

5. The method of claim 1, wherein the variable individual cost component is based on at least one of the individual traveler's costs of the individual's vehicle when moving, a shared cost of the individual's or another traveler's vehicle when moving for carpooling, parking tickets, and transit tickets for the respective time period.

6. The method of claim 1, wherein the graphical representation comprises a bar graph which includes a bar for each of the set of time periods representing the aggregated cost for the time period, in which the components of the aggregated cost are stacked.

7. The method of claim 1, further comprising generating a simulated representation for displaying aggregated costs for a set of time periods to the individual traveler based on a proposed modification by the traveler, resulting in a change to at least one of the traveler's fixed costs and variable costs.

8. The method of claim 1, wherein at least one of the computing of the fixed individual cost component and the computing of the variable individual cost component is based on information acquired from a computing device operated by the individual traveler.

9. The method of claim 1, further comprising acquiring community data, the computed fixed community cost component being based on the acquired community data.

10. The method of claim 1, further comprising receiving a query for a trip from the traveler and ranking a set of proposed trips as a function of the aggregated costs for the traveler for each of the trips.

11. The method of claim 10, further comprising generating a representation of a set of the proposed trips in which the variable costs for each trip are represented.

12. The method of claim 1, further comprising outputting the representation to a display device.

13. A computer program product comprising a non-transitory recording medium storing instructions, which when executed on a computer, causes the computer to perform the method of claim 1.

14. A system comprising memory which stores instructions for performing the method of claim 1 and a processor in communication with the memory for executing the instructions.

15. A system comprising:
a data acquisition component which acquires community data and user data;
a travel cost metric computation component which computes:
a fixed community cost component attributable to each traveler in a community, per time period, based on the community data;
a fixed individual cost component for the individual traveler, per time period, based at least in part on the user data;
for each of a set of time periods, a variable individual cost component for the individual traveler, based at least in part on the user data; and
for each of the time periods in the set of time periods, aggregates the fixed community cost, fixed individual cost, and variable individual cost components;
a representation generator which generates a representation for displaying the aggregated costs for the set of time periods to the individual traveler, and
a processor which implements the data acquisition component, travel cost metric computation component, and representation generator.

16. The system of claim 15, further comprising a trip planner which receives a query for a trip from the traveler and ranks a set of proposed trips based at least in part on the aggregated cost for the trip.

17. A trip-planning method comprising:
computing a fixed community cost component attributable to each traveler in a community, per time period;
computing a fixed individual cost component for an individual traveler, per time period;
receiving a query for a trip from the traveler;
computing a variable individual cost component for the individual traveler for each of a set of proposed trips;
aggregating the fixed community cost, fixed individual cost, and variable individual cost components for each of the proposed trips; and
ranking the proposed trips based on the aggregated cost; and
generating a representation for displaying at least some of the ranked proposed trips which includes at least one of a representation of the variable cost and a representation of the aggregated cost for each displayed proposed trip,
wherein at least one of the computing the fixed community cost, computing the fixed individual cost, computing the variable individual cost, aggregating the fixed community cost, fixed individual cost, and variable individual cost, ranking, and generating a representation is performed with a processor.

18. The method of claim 17, wherein the aggregated cost includes a financial cost and an environmental cost and wherein the ranking is based on at least one of the financial cost and the environmental cost.

19. A system comprising memory which stores instructions for performing the method of claim 17 and a processor in communication with the memory for executing the instructions.
